(19) United States
(12) Patent Application Publication
(10) Pub. No.: US 2007/0129898 A1
(43) Pub. Date: Jun. 7, 2007

(54) Methods of computer modeling a nucleic acid structure

(76) Inventor: Jeffrey John Birac, Edison, NJ (US)

Correspondence Address: Li Su, 223 Normandy Road, Edison, NJ, 08820, US

(21) Appl. No.: 11/634,049

(22) Filed: Dec. 5, 2006

Related U.S. Application Data
(60) Provisional application No. 60/742,767, filed on Dec. 6, 2005.

(51) Int. Cl. G06F 19/00; G06G 7/48; G06G 7/58

(52) U.S. Cl. 702/20; 703/11

(57) ABSTRACT

The present invention provides a method of computer modeling a nucleic acid structure model. The invention also provides a computer readable medium having instructions to perform the method. The invention also provides a molecular modeling apparatus that comprises means for minimizing segment length errors and segment angle errors of the nucleic acid structure. In one embodiment, the segments represent at least two bases, a backbone linkage, rise of a helix, and optionally a nucleoside or tether.

This application claims priority to U.S. provisional application 60/742,767, filed Dec. 6, 2005.

### FIELD OF THE INVENTION

The present invention provides a method of computer modeling a nucleic acid structure model. The invention also provides a computer readable medium having instructions to perform the method. The invention also provides a molecular modeling apparatus that comprises means for minimizing segment length errors and segment angle errors of the nucleic acid structure. In one embodiment, the segments represent at least two bases, a backbone linkage, rise of a helix, and optionally a nucleoside or tether.

### BACKGROUND OF THE INVENTION

DNA based self-assembly has emerged as one of the premier techniques for the construction of complex nano-scale structures. (NCS-SciAm) The double helix itself is fairly rigid, having a persistence length of about 500 Å.¹ Further, sticky-end cohesion can join duplexes in a sequence specific manner.¹ After cohesion, the sticky ends have essentially the same structure as a regular DNA duplex.¹

Structural DNA Nanotechnology (SDN) emerged when methods were developed for joining the arms of branched junctions, mostly via immobile Holliday junctions,² 3-arm junctions,³ and bulged 3-arm junctions.⁴ It was hoped that these junctions could serve as motifs to assemble into larger organized networks. When it was observed that the junctions were highly flexible,^{3,5-6} however, novel strategies had to be developed to build well ordered arrays.

Programs for drawing DNA molecules and computational methods for calculating molecules' conformation have been developed. Many of the methods involve high resolution models with atomic representations, which can be cumbersome, and most likely unnecessary, during the development of a prototype motif. As larger and more complex SDN constructs are developed, the need for alternate methods of modeling has become apparent. Large physical models become distorted, and even unstable under their own weight, and they are not easily reduced below a size scale dictated by the jacks used to join the tubes together. The distortions are particularly pronounced for the newer non-planar motifs that are being developed. Further, construction of the physical models becomes quite tedious, particularly if multiple variations on a large motif are desired for comparison.

### SUMMARY OF THE INVENTION

To solve these problems, we have developed a Graphical Integrated Development Environment for OligoNucleotides. The computer program of this invention provides a user-friendly Graphical User Interface (GUI) that allows straightforward construction and viewing of complex SDN models with ideal precision, free from gravitational distortions, and a relaxation method based on geometrical strain minimization to adjust conformation strain of the models. The relaxation method minimizes the mechanical stresses within a simplified low-resolution geometrical representation of the model.

The present invention provides a method of computer modeling a nucleic acid structure model. The invention also provides a computer readable medium having instructions to perform the method. The invention also provides a molecular modeling apparatus that comprises means for minimizing segment length errors and segment angle errors of the nucleic acid structures. In one embodiment, the segments represent at least two bases, a backbone linkage, rise of a helix, and optionally a nucleoside or tether.

In one embodiment, the molecular modeling apparatus of this invention builds and displays virtual molecular models whose components are single strands, double helices, and single nucleotides. This system allows the user to develop simple yet precise models of SDN units, and evaluate the stresses in various designs. These geometry-based techniques have been shown sufficient to explain broad trends in SDN formation without resorting to complex energetic calculations.

### BRIEF DESCRIPTION OF THE DRAWINGS

FIG. 1. A sample SDN structure: the cube. The top three rows show stereoscopic images of a cube. ²¹ The top row is the abstract geometric shape. The second row shows the reinterpretation of the structure as a network of stiff rod-like edges of DNA duplexes. The third row shows the helical axes and base stacks. Row 4 shows an enlarged view of the near bottom duplex of the cube. Row 5 shows the same duplex without the helical axis, and with the bases assigned different colors. Nucleosides are rendered simply as a sphere with a protruding cylindrical segment, portraying the base¹⁰, and are interconnected by phosphates represented as cylindrical segments. Each sphere is an icon of its nucleoside's coordinates and assigned base, and segments—representing backbone linkages—are created and deleted between spheres to define the connectivity of the nucleosides.

FIG. 2. The integrodifferential response function used to calculate relaxation vectors. The coefficients (k_{d}, kᵢ, kₚ) define the response of an angle or segment. The default coefficients were set empirically based on relaxation of many different structures, but the user is given the option to adjust the coefficients as necessary during relaxation.

FIG. 3. Automatic relaxer examples. Kink relaxation (a-b). The relaxation processor of the computer program of this invention promotes the local rigidity of DNA. A duplex of 39 bp was distorted sharply (bent 90° at two different points along the helix axis). Relaxation resulted with a bend of less than 1° in the helix axis between neighboring base pairs. Hairpin relaxation (c-f). The loop capping a hairpin motif may be constructed from a duplex with one strand trimmed (d) and connected to its complementary strand (connection shown as green segment in e), followed by relaxation of the contorted structure into a uniform loop (f). The loop itself appears simple, but it is quite cumbersome to construct manually. Immobile Holliday Junction with Tethers (g-i).² (g) An immobile Holliday junction drawn with the 4 arms unstacked. In a buffer with divalent cations—such as Mg⁺²—two pairs are of arms are known to stack in an anti-parallel fashion with an angle of about 63° between domains. The user specifies which pairs of arms stack by connecting the base stack axes (black cyllinders) manually. The user can create tethers—non-material entities rendered as thin red cylinders—to restrict the distance between two objects. The model includes tethers specified by the user to force the unassociated vertices—opposite one another across the junction—close together, which will bring the phosphates spanning the junction into close proximity. (h-i) The restrictions imposed by the tethers brings the structure into an antiparallel configuration as can be seen by the downward orientation of the red cone at the 3′ end of the salmon-colored strand and the upward orientation of the dark blue cone at the 3′ end of the light blue strand. The angle between domains is about 21°—lower than the empiracl value, but still in qualitative agreement with the observed structure.⁸

FIG. 4. Construction and Manual Relaxation of a DPOW. (a) Two double helices are drawn next to each other. (b) Nicks are placed on the strands where the two domains are to be joined. (c) Crossover backbone linkages are inserted, and the backbones are re-colored to reflect the new strand identities. At the bottom, the end view of the structure is shown. (d) The duplex domains are moved and rotated so that the backbone segments joining the two domains are the same length as they would be if they joined two nucleosides in the same base stack ˜6.8 Å. This approach can be used to identify low-strain SDN structures. The resulting structures have perfectly undisturbed B-DNA duplex domains, and nominally unstrained connections. This is necessary but not sufficient to guarantee clean formation of the target structure—indeed, the DPOW has been found not to form cleanly. In this regard, parallel DX molecules are known to be difficult to form—most other structures with unstrained geometrical models form well when they do not fall into kinetic traps during formation. See FIGS. 5 and 8 for examples of such structures.

FIG. 5. Left and Right-handed Tensegrity Triangles. The left column shows a left-handed tensegrity triangle with 14 bases between junctions on each side. The right column shows a right-handed tensegrity triangle with 17 bases between junctions. In the top row it is clear that the helical domains in the left-(right-) handed triangles come toward the viewer as one progresses clockwise (counter-clockwise) about the triangle. In the lower 3 rows, the helical axes are marked in blue, and the junctions are indicated by yellow struts that run from one axis to the other directly through the linking crossover. The 14 bases of the left-handed triangle subtend about 1.3 turns, where the 17 bases of the right-handed triangle subtend about 1.6 turns, as can be seen in the bottom row. The immobile Holliday junctions at each corner are more relaxed with the ˜60° antiparallel configuration of the right-handed triangles than the ˜60° antiparallel configuration of the left-handed triangles, though both types have been shown to form.

FIG. 6. Derivation of Tensegrity Triangle Geometry. The blue struts are the axes of the double helical domains forming a tensegrity triangle. The yellow struts represent the lines through the junctions as in FIG. 5 above. Each pair of blue and yellow struts forms a right triangle with hypotenuse shown in red with length t. For a given duplex length, L, and a given duplex diameter, D, the geometrical constraints on the system require a particular angle between pairs of yellow struts. To calculate that angle, put the point 0 at the origin, and calculate the coordinates of point P in 3 dimensions as specified by the equations at right. Then the entire system is specified by 3-fold symmetry about point C. Note that this derivation depends critically upon the three 2-fold and one 3-fold rotational symmetries in the structure.

FIG. 7. Tensegrity Triangles Gels—Monomers or Multimers? Tensegrity triangles were constructed with edge lengths 13 bases (lanes 2-5), 14 bases (lanes 6-9), 15 bases (lanes 11-14), 16 bases (lanes 16-17), 17 bases (lanes 19-22) and 18 bases (lanes 23-26). Room temperature non-denaturing polyacrylamide gels show the triangles annealed at different concentrations. For each gel, the first lane is for reference—a pBR322 Haelll digest, with a gray dash marking the 184 base pair band, and a black dash marking the 124 base pair band. The three larger gels are 10% acrylamide, and the Mao triangles were run at 12 μM, 6 μM, 3 μM, and 1.5 μM in order left to right. The small gel is 8% acrylamide. Lane 17 was run at 4 μM. Lane 16 shows material was taken from an earlier gel run where the monomer target band was cut out, eluted, and reannealed at 4 μM. The tendency of the systems to form multimers is proportional to the strain calculated in the text. The least multimer-prone structures are tensegrity triangles with 14 bases on an edge (left-handed), and 17 or 18 bases on an edge (right-handed).

FIG. 8. Base Tilt Models of DX and TX molecules. Careful models were made, following the method shown in FIG. 4. In this case, the 60° tilt of the bases in solution B-DNA was included in the model. For the DX's, the backbone segments of the crossovers are colored from left to right in alphabetical order: blue, brown, green, red. Front, top and left views of each structure are shown. (a) A DAO structure, showing ˜3° misalignment of the domains. ⁷ (b) A DAE with 10 bases between junctions and ˜10° misalignment of the domains. ⁷ (c) A DAE with 21 bases between junctions showing ideal alignment of the domains. ⁷ (d) A TX with odd number of half turns between junctions,¹² the top and bottom domains are both turned in the same direction relative to the middle domain—about 3°, with the upper domains turned a bit more. (e) A TX with an even number of half turns between junctions.²⁷ The domains are parallel, but the upper domain is ˜17° out of the plane defined by bottom two. (f) A DPE showing parallel domains. The DPE is the only one of these structures known not to form cleanly.⁷

FIG. 9. Sterics of Tensegrity Triangles with DX Reinforcements. A tensegrity triangle, shown in yellow in all panels is reinforced by adding a second, gray duplex domain to each leg of the triangle. The gray-yellow domain pairs form DAE structures with 42 bases between junctions. The only difference between the structure in the left panels and those in the right panels is that the crossovers in the DAE's have been moved one base over. The difference is hardly visible in the top row, and can not be resolved in common physical models, but the structure on the right has a steric clash between the gray outer domains and the neighboring yellow domains that can be seen in (d) where the gray domain running toward the viewer overlaps the yellow domain running downward to the left.

FIG. 10. is a labeled screen display of the Document window; the primary window of the Graphical User Interface (GUI) of the program.

FIG. 11. is a screen display of the Duplex Specifications window for one embodiment of the invention, where the user enters the specifications of a newly created duplex. The specifications of a duplex are defined as follows:

Location (angstroms): the x, y and z coordinates of the helix axis at the first base pair.

Orientation (degrees): the Roll, Phi and Theta angles that define the direction of the helix axis at the first base pair.

Length (base pairs): the counted number of base pairs in the duplex.

Radius (angstroms): the distance from the helix axis to the edge of the duplex (the end of a base segment).

Pitch (angstroms): the distance along the helix axis per a 360 degree helix turn.

Frequency (base pairs/turn): the counted number of base pairs in one 360 degree helix turn of the duplex.

Minor Groove Angle (degrees): the angle between the base segments of a base pair.

Phase (degrees): the right-handed shift in the twist of the duplex relative to a duplex with specified phase of zero.

Bend (degrees): the supplement angle between two adjoined helix rise segments to measure deviation from a straight helix axis.

Sequence: The user may specify the sequences of the strands in the new duplex; the Length is adjusted as the user enters the sequence; one strand is assigned the entered sequence, while the second strand is assigned the complementary sequence.

Locked (true/false): When true, modification of the sequence—perhaps by an automatic sequence operation—is prevented unless specified by the user (after the duplex has been created.)

The specifications shown in the figure imply the following target segment lengths and target segment angles:

Backbone linkage length: 6.8053 angstroms.

Base length: 10 angstroms.

Helix Rise length: 3.4 angstroms.

Backbone angle: 150.414 degrees.

Minor Groove angle: 137.5078 degrees

Twist angle: 34.285 degrees.

Tilt angle: 0 degrees.

(Axis) Persistence angle: 180 degrees

FIG. 12. is a flowchart setting forth a method of relaxing (minimizing) the mechanical strain in a geometrical model of a nucleic acid molecule. The method begins at data step 1 with a list of items to be processed (segment lengths and segment angles), then process step 2 fetches the first item to be processed and the Error—deviation of item's Current State from the item's Relaxed State—is calculated in process step 3. Process step 4 accumulates each item's Error for later examination in decision step 15. The process continues to decision step 5 to decide whether to modify the item's Current State. If the decision is to modify the item's state, then the Magnitude of Response—the amount of modification—is calculated in process step 6 based on the item's Error. The Relaxation Vectors that will effectively modify the item's Defining Vertices are calculated in process step 7. To allow all items to be processed under the same conditions—the same state of the model—the calculated Relaxation Vectors are accumulated (into a buffer) in process step 8 for use later in process step 11. If any of the items have not been processed, then decision step 9 branches to process step 10 to fetch (from the list in data step 1) an unprocessed item; the process then loops back to process step 3. Otherwise, when all items have been processed, decision step 9 branches to process step 11 to apply (and then dispose them in process step 12) the Relaxation Vectors that were accumulated in process step 8. Process step 13 detects and eliminates Collisions between objects in the model (including but not limited to segments). If collisions were detected, then decision step 14 branches to process step 17 to repeat the algorithm from process step 2. If no collisions were detected/eliminated, then decision step 14 will branch to decision step 15. Decision step 15 considers the amount of Error accumulated in process step 4. If the Overall Error is less than an Overall Error Tolerance (default 0.01%), then decision step 15 will branch to stop step 18. Otherwise, decision step 15 will branch to decision step 16. If the Actual Displacement of a vertex—the sum of all its applicable Relaxation Vectors in process step 11—is less than a specified Equilibrium Tolerance (default 104 angstrom), then the vertex is in a state of Equilibrium. If decision step 16 infers a Conformation Equilibrium state of the model—all vertices are in equilibrium—then decision step 16 will branch to stop step 18. Otherwise, decision step 16 branches to process step 17 to repeat the algorithm from process step 2.

FIG. 13 is a screen display of default Relaxation Force Constants: Proporational Gain, Integral Gain and Differential Gain for backbone linkage length, base length, helix rise length, tether length; backbone angle, minor groove angle, twist angle, tilt angle and persistence angle from top to bottom.

### DETAILED DESCRIPTION OF INVENTION

The term “base” refers to a base or modified base of RNA, DNA, modified RNA, modified DNA or peptide nucleic acid.

The term “backbone linkage” refers to the linkage between two neighboring nucleosides or modified nucleosides in RNA, DNA, modified RNA, modified DNA or peptide nucleic acid.

The term “collision” refers to at least a point of contact between two objects in the model.

The term “rise of a helix” or “helix rise” refers to the distance along the helix axis between two adjacent bases.

The term “nucleoside” refers to nucleoside or modified nucleoside of RNA, DNA, modified RNA, modified DNA or peptide nucleic acid.

The term “segment angle” refers to the angle between at least two segments. Examples of segment angles for nucleic acids include but are not limited to twist angle, minor groove angle, backbone angle, persistence angle and tilt angle.

The term “planar angle” is defined by two segments with a common endpoint.

The term “torsion angle” is defined by a linear chain of three segments joined end-to-end.

The term “backbone angle” refers to the angle between (two) neighboring backbone linkage segments.

The term “twist angle” refers to the torsion angle around the helix axis between (two) neighboring base pairs.

The term “tilt angle” refers to the complement of the angle between a base and the helix axis.

The term “minor groove angle” refers to the angle between the base segments of a Base Pair.

The term “persistence angle” refers to the angle between two neighboring helix rise segments.

The term “segment” refers to an interconnection between two vertices that can be any geometric shape. For example, in nucleic acid structures, a segment can define the bases, backbone linkage or rise of the nucleic acid helix or tether. The geometric shape can include but is not limited to a cylinder or a plane.

The term “tether” refers to an interconnection between two vertices that represents an interaction in the nucleic acid structure, between nucleic acid structures, or between a nucleic acid structure and an object. For example, to represent interactions such as non-conventional covalent bonds (i.e., base cross linking), ionic, aromatic, hydrophobic, van der waals and electrostatic interactions.

The term “nucleic acid structure” refers to DNA, RNA, modified DNA or RNA, and peptide nucleic acid.

“Error” refers to the difference between a segment length and a target segment length, or difference between a segment angle and a target segment angle.

“Overall Error” refers to a quantity describing the error as a whole based on each error (e.g., RMS of percentage of discrete errors). For example, overall segment length error or overall segment angle error.

The term “Relaxation Vector” refers to a vector applied to the segment endpoints (vertices) to minimize the error. The magnitude of the vector can be derived from the Magnitude of Response. In one embodiment, the vector's magnitude is equal to half of the Magnitude Of Response of the segment. In one embodiment, the vector's orientation is along the line passing through both Defining Vertices—endpoints—of the Segment. The vector is oriented toward the Segment's midpoint when the Error is positive to shorten the Segment. The vector is oriented away from the Segment's midpoint when the Error is negative to lengthen the Segment.

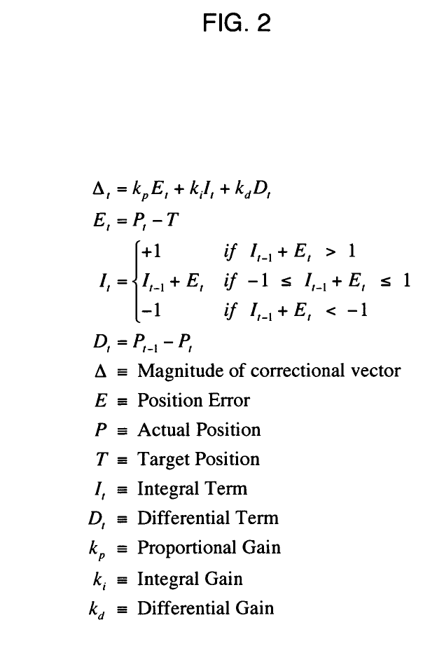

The Response Function illustrated in FIG. 2 can be used to calculate the Magnitude of Response based on the current state and previous state of a segment length or segment angle during the relaxation process. The Position Error is a number quantifying the amount the current state deviates from the relaxed state (i.e., error between the segment length and target segment length). The Target Position is a number quantifying the relaxed state (i.e., target segment length). The Actual Position is a number quantifying the current state (i.e. segment length). The Integral Term is a number between +1 and −1 that is the summation of previous Position Errors. The Differential Term is the difference between the Actual Positions of the previous and current repetitions. The Proportional Gain, Integral Gain and Differential Gain are constants that weight the significance of the Position Error, Integral Term and Differential Term, respectively, summed to derive the Magnitude Of Response.

In one embodiment, the method of the invention is a geometry based design strategy for DNA nanostructures. In one embodiment, models are built on a simple model of undistorted B-DNA double-helical domains. In other embodiments, the methods of this invention may be applied to RNA, modified RNA, modified DNA, peptide nucleic acid. RNA or DNA may be modified at one or more of the base, nucleoside, phosphodiester linkage positions.

As the nature of SDN molecules are networks of nucleic acid strands, in one embodiment, linked arrays of data units encapsulate specifications of a structure's connectivity. In one embodiment, the data units include nucleosides—sugar-base valence groups—and phosphates.

In another embodiment, the program is defined as a hierarchy of logical data units. The hierarchy can start with nucleotides at the lowest rank. In addition to its positional coordinates, a nucleotide can encapsulate other private data, such as a reference to its Watson-Crick mate nucleotide, the assignment of its associated base (A, C, G, T) if desired, and the connectivity within its resident strand. A nucleotide, rendered as a sphere to represent its sugar, holds the logical assignment of the base. In one embodiment, strands and duplexes, defined while the user constructs the model, hold the next rank in the data hierarchy. A strand (data unit) maintains an array of linked nucleotides, and may be addressed as a single object to change its visibility and to organize the connectivity. Each backbone linkage can specify the connectivity of the strands. Additional segments and spheres are distributed in a periodic fashion through the interior of a duplex to represent its stacked bases and helix axis. A duplex data unit encapsulates the stack of bases associated with the axial vertices and base segments, and may also be addressed as a single object for reconfiguration and analysis of a portion of a structure.

When building SDN computer models without preliminary coordinate calculations, it is often difficult to align all the components perfectly. The computer program of this invention has been equipped with a rudimentary relaxation process that can help fit the elements of a construct together in a smooth and low-stress configuration. This relaxation process can also be used to get qualitative estimates of the strain expected for a given design.

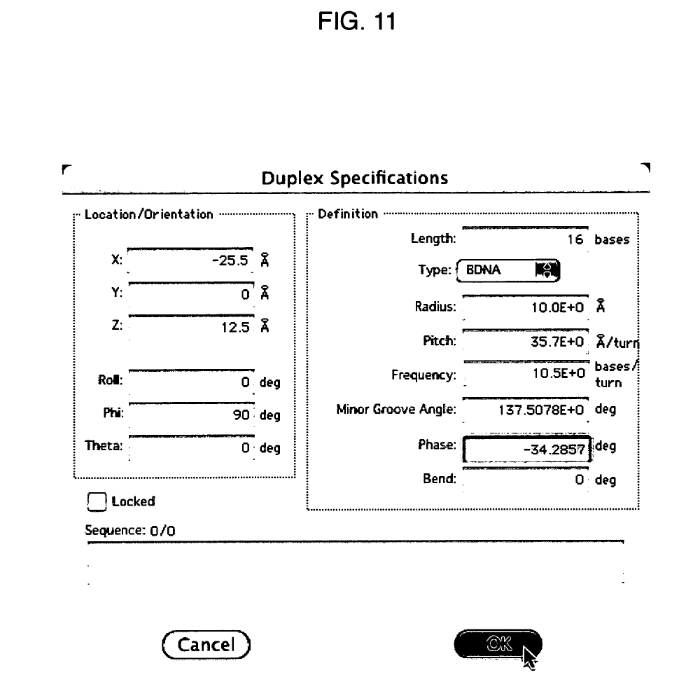

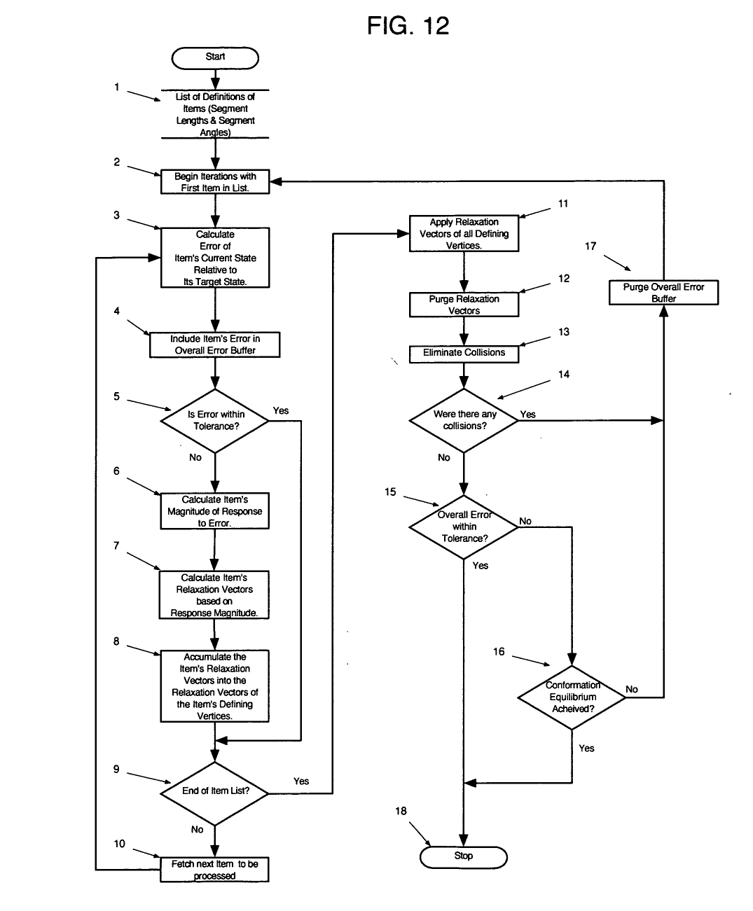

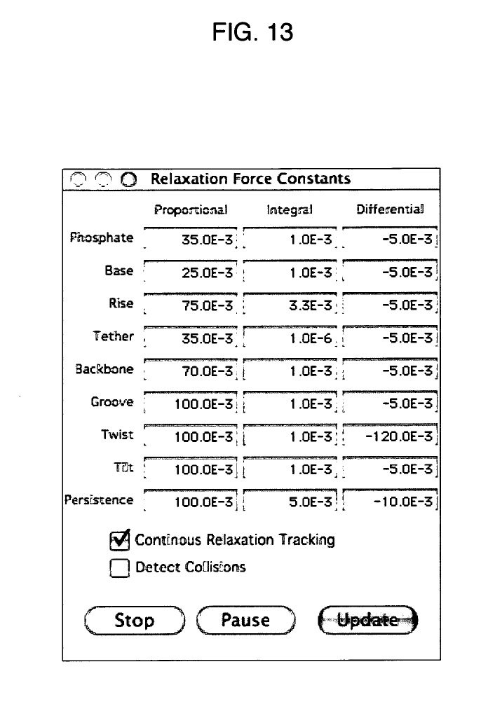

Once the relaxation has begun, the structure will gradually rearrange itself to minimize mechanical stress according to user specifications (see for example FIG. 11). Each segment has a target length, set implicitly during construction, which defines its relaxed state. A tensile (or compressive) stress arises due to a difference—also known as an “error”—in a segment's current length relative to its target length. During an iteration of the relaxation process, two vectors calculated as a function of each segment's orientation and error length translate the segment endpoints. The vectors shorten or lengthen each segment to reduce its error.

A similar approach is taken in minimizing angular stresses—planar and/or torsional. Each segment and angle follows its own integrodifferential response function (see FIG. 2) used to calculate its relaxation vectors; oscillations of the structure are dampened during relaxation.²² The coefficients (k_{d}, kᵢ, kₚ) define the response of an angle or segment, but no optimal set of coefficients has been derived. The default coefficients were set empirically based on relaxation of many different structures (see for example FIG. 13), but the user is given the option to adjust the coefficients as necessary during relaxation.

Therefore, the invention provides the method of computer modeling a nucleic acid structure model comprising:

a) using a computer to construct a nucleic acid structure model comprising segments defining segment lengths and segment angles,

b) adjusting the segment angle to minimize the error between a segment angle and a target segment angle, or adjusting the segment length to minimize the error between a segment length and a target segment length, or both by computation.

In one embodiment, the segments represent at least two bases, a backbone linkage, rise of a helix, and optionally a nucleoside or tether. In another embodiment, the nucleoside is represented as a vertex, and the segments represent at least two bases, a backbone linkage, rise of a helix, and optionally, a tether. In one embodiment, the segments represent at least a base, a backbone linkage, and optionally a nucleoside or tether. In another embodiment, the nucleoside is represented as a vertex, and the segments represent at least a base, a backbone linkage, rise of a helix, and optionally, a tether.

In one embodiment, step a) comprises the step of inputting precise numerical inputs for constructing the model. In another embodiment, step a) comprises the step of inputting one or more of a nucleic acid sequence, orientation or location of a nucleic acid structure and structure parameters of a nucleic acid structure. For example, inputting specifications of a DNA duplex as shown in FIG. 11, including but not limited to the location, orientation, length, radius, pitch, frequency, minor groove angle, phase, bend and sequence. Other nucleic acid parameters that can be inputted are described in Nucleic Acid Structures, Saenger. This gives the advantage of taking into consideration any geometrical structural calculations made prior to drawing the molecules.

In a further embodiment, in step a), the user starts out with choosing the motif's concept geometry, which could be as simple as a single line or contour. Then, the user can translate the motifs into association of for example, strands, helices, junctions and sticky ends of a nucleic acid. The user can then create the model's rudimentary structural components, for example, strands and double helices of a nucleic acid. Finally, the user can define the connectivity (segments) of the components. For example, a strand is divided into two smaller strands when a backbone linkage segment on the parent strand is deleted; two strands are connected to form one larger strand by creating an end-to-end backbone linkage segment between the strands.

In one embodiment of the invention, step b) comprises the steps of:

i) calculating a segment length error or a segment angle error;

ii) calculating the magnitude of response using the segment length error or segment angle error;

iii) calculating a relaxation vector based on magnitude of response;

iv) reiterating steps i) to iii) with a different segment length or segment angle;

v) applying relaxation vectors calculated in the reiteration steps of iv) to vertices to adjust a segment length or segment angle.

In another embodiment, the above methods further comprise the step of eliminating collisions in the model.

In another embodiment of the invention, the method further comprises the step of:

comparing the overall error of the segment angles to the overall segment angle error tolerance or comparing the overall error of the segment lengths to the overall segment length error tolerance.

In yet another embodiment of the invention, the method further comprises the step of:

determining if the sum of all relaxation vectors of a vertex is less than a specified equilibrium tolerance.

In another embodiment, after the relaxation steps above, the nucleic acid structure is automatically given a sequence by the program based on the connectivity and association of the strands. In one embodiment, the nucleic acid structure is outputted to an output device during the computer modeling process. Outputs include but are not limited to simple picture files, stereoscopic images, movies, nucleotide coordinates, as well as strand lists and base complementarity files. The coordinates, connectivity, associations and sequences of the model may be exported from the computer program in text format. The output makes it an ideal front end for sequence generators, X-ray scattering simulators and other post-processing. In another embodiment, the segment length error or segment angle error is outputted. The outputs include but are not limited to CDs, disks, printers and screen displays.

In another embodiment, the methods of this invention further comprises the step of calculating thermodynamic energy, melting temperature of the modeled structure, or simulating structure dynamics of the modeled structure, or a combination thereof.

The invention also provides a computer readable medium having instructions stored thereon which configure a general purpose computer to perform any of the methods mentioned above.

In a further embodiment, the invention provides a molecular modeling apparatus comprising:

An input device for accepting user commands to construct a nucleic acid structure;

Means for outputting a multi-dimensional representation of said nucleic acid structure;

Means for minimizing the segment length errors and segment angle errors of the structure.

In one embodiment, the segments represent at least two bases, a backbone linkage, rise of a helix, and optionally a nucleoside or tether. In another embodiment, the nucleoside is represented as a vertex, and the segments represent at least two bases, a backbone linkage, rise of a helix, and optionally, a tether.

In one embodiment, the molecular modeling apparatus additionally comprises means for outputting one or more of the overall segment length error, overall segment angle error, a segment length error and a segment angle error.

In another embodiment, the molecular modeling apparatus additionally comprises means for modifying the nucleic acid structure. A relaxed structure may assume an unexpected conformation and reveal major internal stresses that need to be resolved. The computer program of this invention enables a simple and reliable approach to revising the structure to influence its relaxed conformation. Simple point and click manipulations of the model allow the minimization of strain in the backbone linkages between domains and the identification of any steric clashes that might occur as a result. Repositioning duplexes, adjusting the separation—number of nucleotides—between junctions, or changing the connectivity of the strands by the user, along with subsequent relaxations, may be repeated until the desired conformation is achieved. In one embodiment, the modeling apparatus comprises means for automated script construction of structures. Instead of manual creation, modification and connection of structural components, the construction can be achieved by a script command.

In a further embodiment, the apparatus comprises means for checking steric clashes or collision of a model. In another embodiment, the apparatus comprises a stereoscopic projection display system. This kind of display system aids the user with editing complicated models and gives the user a full sense of the model's conformation. In another embodiment, the apparatus comprises means for producing a sequence based on the connectivity and association of the strands of the modeled structure.

The molecular modeling apparatus of the invention comprise software code which configures a general purpose computer to display multidimensional models of relaxed molecular structures which underwent geometrical stress minimization. The code is typically provided to a user on a computer readable medium such as a CD-ROM or floppy disk. Once installed on a computer, the code is generally stored on a hard disk drive in the user's computer system. The nature of the computer may vary widely, and may include mainframes, mini-computer workstations, or personal microcomputers. The host computer system comprises data processing hardware including a computer readable memory such as semiconductor RAM and a hard disk drive for storing the code, as well as an associated display. The host system also typically includes input devices such as a keyboard and mouse or accepting user commands. It will be understood that the host hardware is conventional in nature and will not be described in further detail.

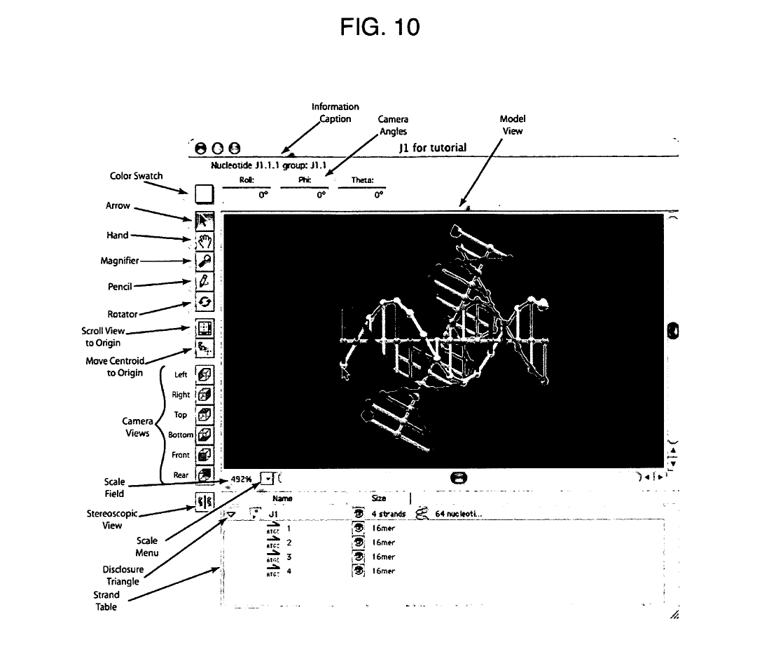

Illustrated in FIG. 10 is a user interface which is output on the display. This interface includes a region containing a display of a user-defined molecule, and may also include toolbars defining user commands allowing modification and manipulation of the displayed molecule. User modification of a molecule may include the ability to add and delete segments from the molecule. The user may also be able to rotate or otherwise manipulate the display of the model. A wide variety of alternatives for the mouse and keyboard implemented alteration and manipulation of molecular model displays are known in the art, and may advantageously be used in conjunction with the invention described herein.

In one embodiment, the invention provides a method of using a computer to connect separate nucleic acid molecules comprising the steps of:

a) connecting at least the 5′ end of one nucleic acid strand to at least the 3′ end of another nucleic acid strand; and

b) outputting at least a continuous nucleic acid sequence from the connected nucleic acid strand.

In one embodiment, step a) is performed by selecting two nucleotides and implementing a user command.

In another embodiment, the invention provides a method of using a computer to cleave a nucleic acid molecule comprising the steps of:

a) cleaving a nucleic acid molecule between two nucleotides to produce two separate nucleic acid molecules; and

b) outputting the sequence of at least one of the cleaved nucleic acid molecules.

In one embodiment step a) is performed by selecting the linkage between the two nucleotides and implementing a user command.

In yet another embodiment, the invention provides a method of using a computer to exchange a portion of a nucleic acid sequence between two nucleic acid strands comprising the steps of:

a) cleaving at least one first nucleic acid strand;

b) cleaving at least a second nucleic acid strand;

c) connecting the 5′ end at the cleavage site of the first nucleic acid strand to the 3′ end at the cleavage site of the second nucleic acid strand;

d) outputting the nucleic acid sequence of the connected strand formed in step c).

e) optionally, connecting the 3′ end at the cleavage site of the first nucleic acid strand to the 5′ end of the cleavage site of the second nucleic acid strand; and

f) optionally, outputting the nucleic acid sequence of the connected strand formed in step e).

In one embodiment, the first nucleic acid strand is a strand of a first nucleic acid duplex, and the second nucleic acid strand is a strand of a second nucleic acid duplex. In another embodiment, step a) to c) or e) is performed by selecting a nucleotide linkage on the first nucleic acid strand and a nucleotide linkage on the second nucleic acid strand and implementing a user command.

In a further embodiment, the invention provides a method of using a computer to detect basepair mismatch between nucleic acid sequences comprising the steps of:

a) inputting at least two nucleic acid sequences;

b) detecting and outputting the number of basepair mismatches between the two nucleic acid sequences.

In one embodiment, prior to step b), a user command is implemented to specify which regions of the two nucleic acid sequences are to be compared. In one embodiment, the number of consecutive basepair mismatches is detected and outputted. In another embodiment, the user specifies the threshold number of mismatches in order to limit the output. In a further embodiment, two nucleic acid duplex sequences with sticky ends are inputted, and the number of basepair mismatches at the sticky end junction is detected and outputted.

### EXAMPLES

The strategies have been implemented with the computer program of this invention—a Graphical Integrated Development Environment for OligoNucleotides. The computer program of this invention has a highly flexible graphical user interface that facilitates the development of simple yet precise models, and the evaluation of stresses therein.

Detailed models of a number of SDN motifs such as double crossover and triple crossover molecules were constructed by the computer program of this invention. The non-planarity associated with base tilt and junction mis-alignments were evaluated. Computer modeling using a graphical user interface overcomes the limited precision of physical models for larger systems, and the limited interaction rate associated with earlier, command-line driven software.

We also present a complete analysis of the geometry of 3D tensegrity triangles, developed by Mao and his colleagues,²⁰ along with experimental evidence showing the accuracy of the resulting structural predictions. We have carried out experiments that confirm that 3D triangles form well only when their geometrical strain is less than 4% deviation from the estimated relaxed structure. Thus geometry-based techniques alone, without energetic considerations, can be used to explain general trends in DNA structure formation.

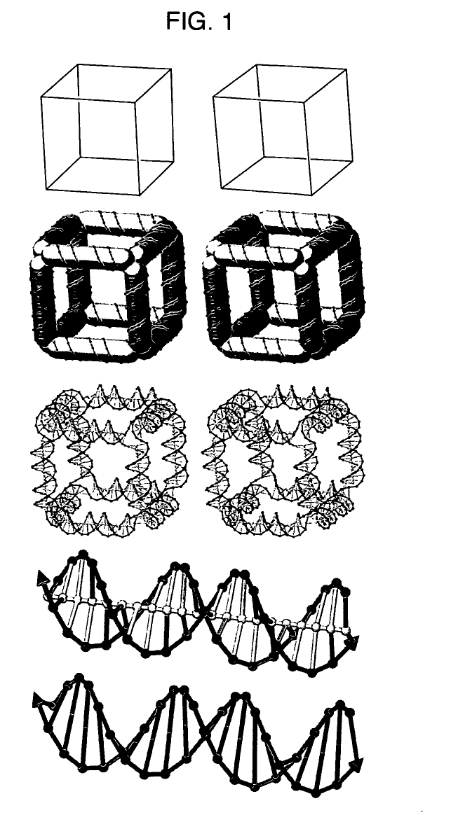

FIG. 1 illustrates an SDN cube.²¹ The top row shows the abstract geometrical structure. The second row shows a stereoscopic drawing of the cube with each duplex domain filled in with a cylinder to emphasize the overall geometric structure. The third row shows a stereoscopic drawing including the internal struts of the duplexes. The bottom row shows an enlarged view of one of the duplexes that makes up the cube. The versatility of the graphical output modes eases both the design and the presentation of the structures.

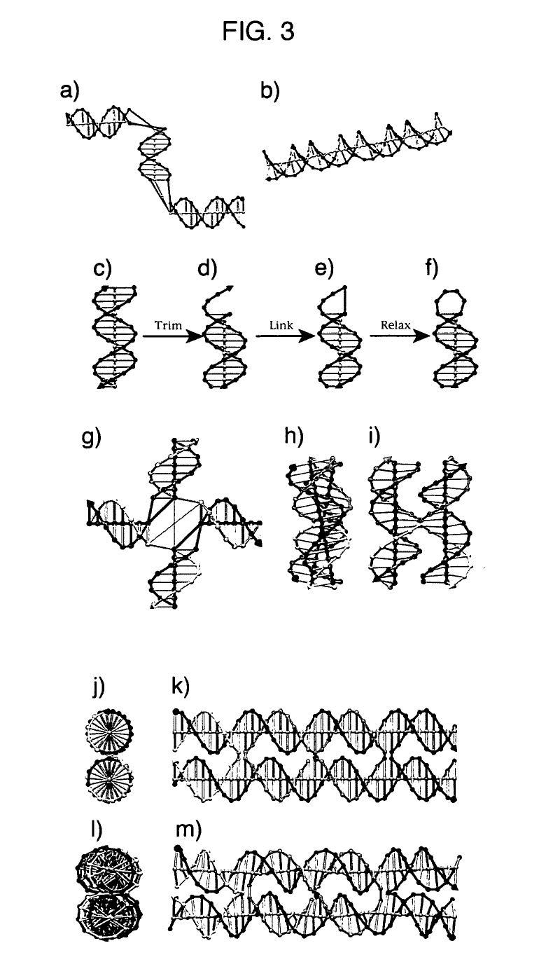

FIG. 3 shows assorted uses of the relaxation function. Panel a shows a duplex bent twice, and b shows that duplex after relaxing overnight. Panels c through f show how a smooth hairpin loop can be constructed from a duplex by first removing one of the strands and the base stack, then linking the two strands together (f), and finally relaxing the loop for a few seconds to a smooth conformation. Panel g shows an unrelaxed 4-arm junction. The user indicates which arm is supposed to stack on which other arm by connecting the central axes (black). Even with this input, the system will not relax to the anti-parallel configuration⁸ that such junctions are known to prefer without additional user input. In this case, 2 pairs of bases have been connected via tethers, shown as thin, red lines, that have an assigned target length. Panels h and i show the result of an overnight relaxation. The pink strand runs downward along one duplex domain, with its 3′ end indicated by the bright red cone at the bottom. Similarly, the bright blue cone at the top of the blue strand shows that it is running upward. Thus the structure is anti-parallel, in this case with an angle of about 21°—substantially less than the typical value around 60°,⁸ but the relaxation result can be adjusted by changing the target lengths and spring constants of the tethers. Panels j-m show the side and front views of two DX molecules that have been relaxed. The upper molecule, with 21 bases between junctions, is unstressed and the two duplex domains can be seen to remain virtually undistorted in their B-DNA structure. The lower DX (panels l and m), has only 19 bases between crossovers, and the relaxer reveals that the system is substantially strained as can be seen by the distortions in the duplexes generated in this configuration. This does not guarantee that the 19 base DX won't form, but the 21 base structure is much more promising and in this case, it is known to form well.⁷

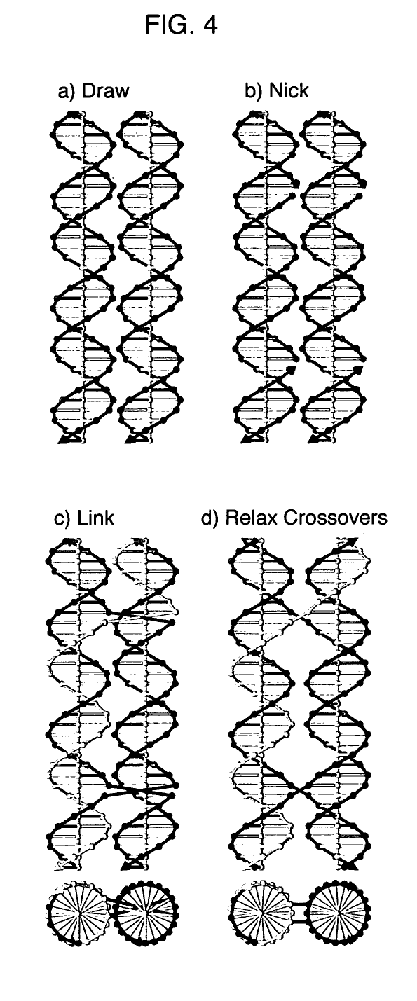

FIG. 4 shows the steps involved in modeling a DX molecule with Parallel domains, an Odd number of half-turns between crossovers, with the extra odd half turn being Wide (DPOW). ⁷ First two duplexes are drawn next to each other an arbitrary distance apart (a). Then nicks are placed in the two duplexes where junctions between domains are going to be (b). Then the desired connections between the strands are inserted (c). Each of the compound strands that were multi-colored have been set to a single color, so each strand can be easily distinguished. Finally (d), the duplex domains are rotated and shifted apart so that all the phosphate linkages between the two domains are at their normal length—taken in this model to be about the 6.8 Å of the phosphate linkages in the double helix. The final step is where the crucial geometrical information goes into the model. In this example, all the crossover strands could easily reach their target lengths at once. In more difficult cases, there needs to be some strain in the system, and the duplexes need to be adjusted to a state that balances the torques on the various base stacks.

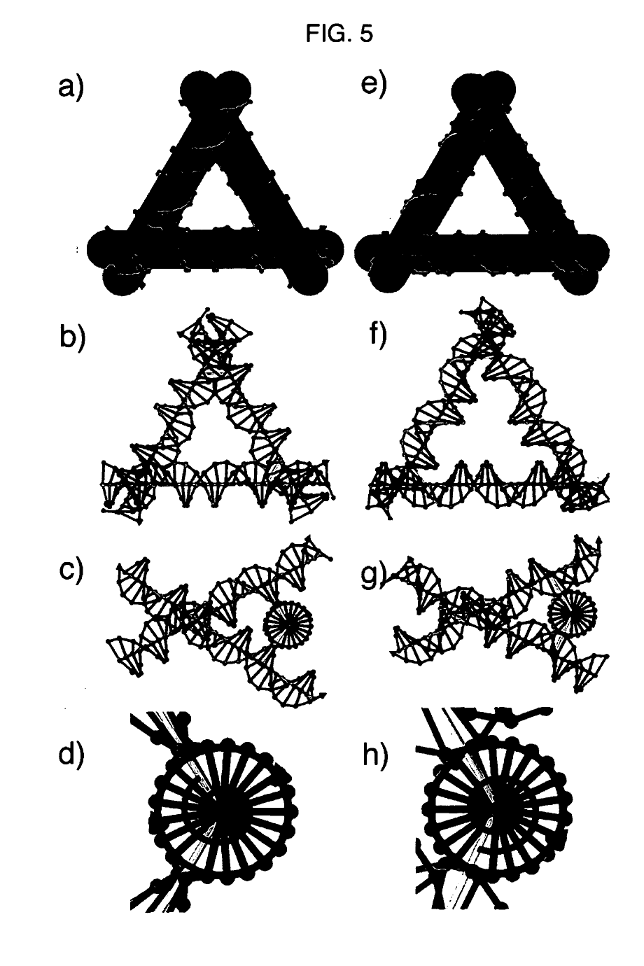

FIG. 5 shows drawings of two tensegrity triangles.²⁰ On the left (a-d), a left-handed triangle is shown—one where the domains move away from the viewer as one proceeds counter-clockwise around the triangle. On the right (e-h), is a right-handed triangle. In panel c, the left-handed triangle is viewed down one edge, and one can see the two yellow struts forming an angle between the junctions with the two other domains. The triangle can only form if the correct angle is formed by the bases along the edge of the triangle. In panel d, we see that approximately 1.3 turns are made by the 14 bases along the edge. In contrast, in panels g and h, about 1.7 turns are made by the 17 bases. Since each base of solution B-DNA has an average of 34° twist,^{23,24} a substantial deviation from the target angle can be generated by making each edge slightly longer or shorter. Additionally, as the length of the edge changes, the target angle shifts as well. Calculating the desired angles between junctions and predicting what structures will form is helpful for building this structure that is becoming an important SDN motif.

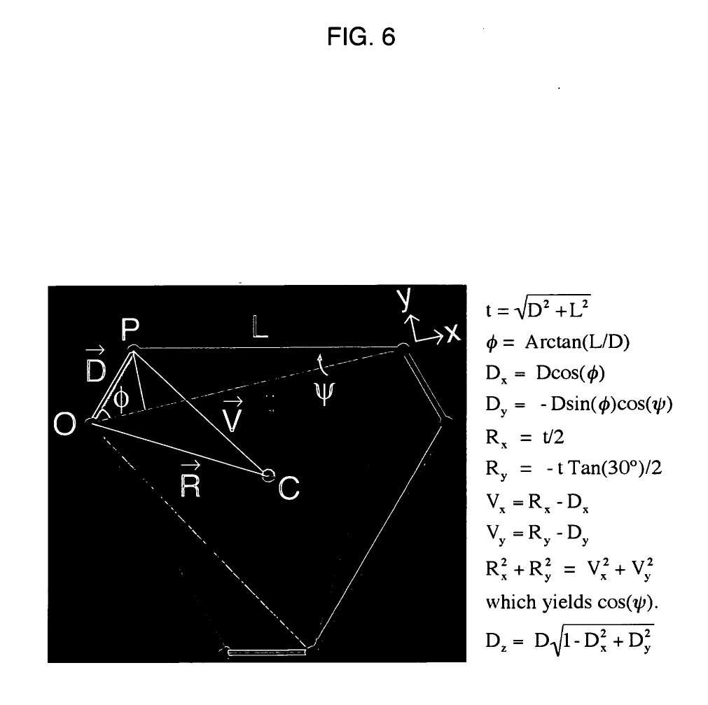

For the 3-fold symmetric tensegrity triangles,²⁰ an analysis is illustrated in FIG. 6. The structure has been abstracted to three helical axes of length L, shown in blue, with yellow struts representing the junction spacings, each of length D, approximately equal to the diameter of a double helix. Each segment of the resulting hexagonal structure is perpendicular to its two neighbors in 3-space. L and D are presumed to be known, which yields the angle, φ, and the length, t. The angle ψ, indicates the angle of the L, D plane about the red edge. Without loss of generality, one can put point O on the origin, with the x-axis along edge t, and the z axis parallel the 3-fold axis of the structure. Define the vector D running from O to P, R running from O to C, and V running from C to P. If we can find all three components of D, then we will have determined the geometry of the entire hexagon, and effectively solved the problem. The x- and y-components of D, R, and V are trivial to calculate as functions of D, t, φ, and ψ, all of which are known except ψ. Due to the 2-fold rotational symmetries of the structure, the magnitudes of the vectors (Rₓ, R_{y}) and (Vₓ, V_{y}) are equal, which allows one to solve for ψ, and then D_{z},. See FIG. 6 for details. We have produced a simple spreadsheet that takes as user input the number of bases desired on each edge of a triangle and outputs the percentage of over/underturning necessary to form the triangle, as well as the coordinates to input into the computer program of this invention to draw the structure with optimal symmetry.

If one supposes that the closest distance of approach between the axes of joined duplex domains in a tensegrity triangle is 23 Å, one can find what edge lengths generate triangles of minimal strain. The strain is measured in terms of percentage of extra twist needed in each base to have the junctions be exactly in the optimal place along each domain. The following was predicted: for 13 bases, the strain is minimal for a left handed triangle with —5.7% strain; for 14 bases, left handed, 1.3% strain; for 15 bases, left handed, 7.4% strain; for 16 bases, right handed 9.6% strain; for 17 bases, right handed, 2.8% strain; for 18 bases, right handed, —3.3% strain.

To test these predictions, we built tensegrity triangles with every possible edge length from 13 to 18 bases. The strands were synthesized by conventional phosphoramidite procedures²⁵ and were purified by denaturing polyacrylamide gel electrophoresis. Stoichiometric mixtures of the strands (estimated by OD260) for each triangle were prepared separately in a solution containing 40 mM Tris-HCl, pH 8.0, 20 mM acetic acid, 2 mM EDTA, and 12.5 mM magnesium acetate. Each mixture was cooled from 90° C. to room temperature in a 1-L water bath over the course of 48 h.

### RESULTS

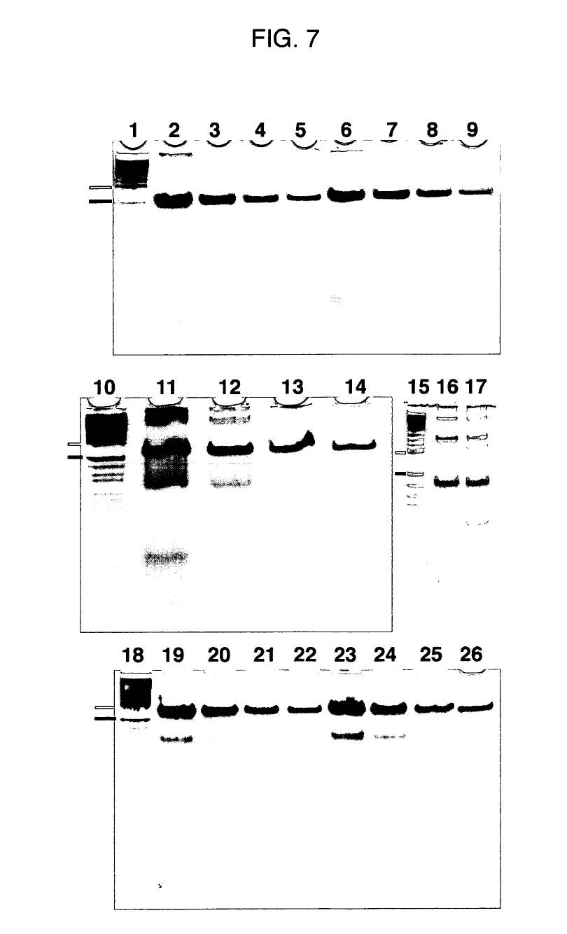

FIG. 7 shows non-denaturing polyacrylamide gels run on a variety of tensegrity triangles. The left lane of each gel is a pBR322 HaeIII digest, with a gray dash marking the 184 base pair band, and a black dash marking the 124 base pair band. Lanes 15-17 are in an 8% gel, while all other gels were 10%. For each triangle, the lower bands indicate small stoichiometry errors, but the upper bands are more serious problems. They indicate the formation of multimers, which occur primarily when the monomer is too strained to fold in a closed complex. The triangle with 13 nucleotides/edge has a significant upper band at 12 μM, while the 14 base/edge triangle had only a faint upward streak at 12 μM. The 15 base/edge triangle had clear upper bands at 3 μM, and slight upper bands even at 1.5 μM. The 16 base/edge triangle had heavy upper bands at 4 μM (lane 17), which remained even after the monomer lane was cut out and the triangle reannealed (lane 16). The 17 and 18 base/edge triangles have no visible upper bands even at 12 μM. Thus the tendency to form multimers tracks well with the strains of the systems calculated above, and similar calculations have successfully guided the construction of other tensegrity triangles in this laboratory.²⁶

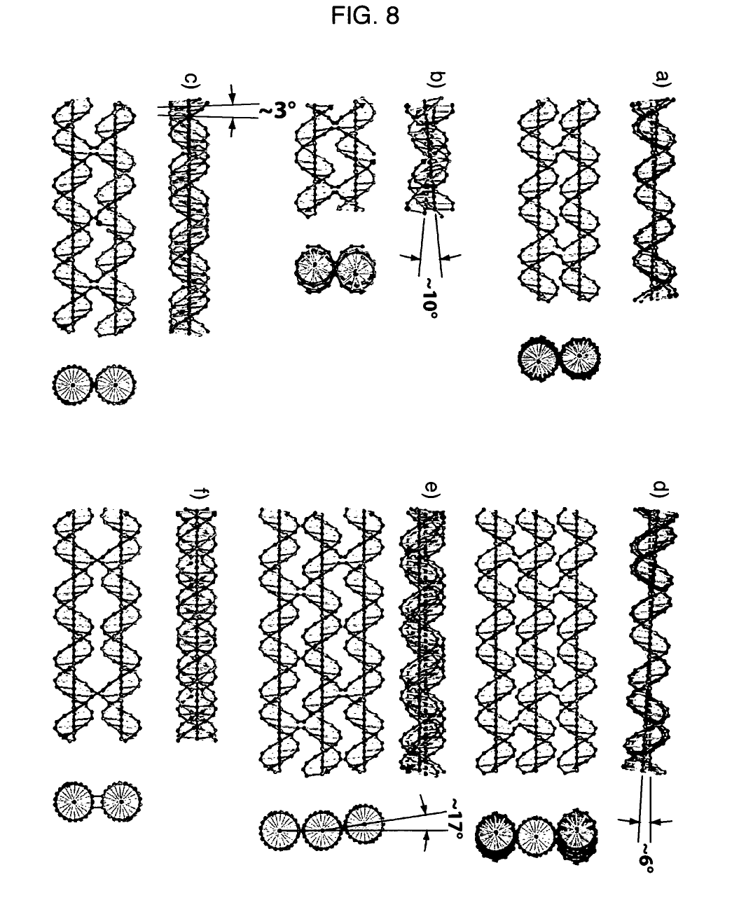

The computer program of this invention allows similar modeling strategies to be easily applied to other SDN motifs. For instance, various DX and Triple Crossover (TX) molecules are, perhaps, the most commonly used SDN motifs.^{7.21} They are generally taken to be flat, but precise modeling with the computer program of this invention reveals, in many cases, slight deviations from planarity. FIG. 8 a shows a model of a DX with Antiparallel domains, and an Odd number of half-turns between crossovers (DAO). The two domains are actually about 3° off from parallel. FIGS. 8b and c are two DX's with Antiparallel domains and an Even number of half-turns between crossovers (DAE's). The first one has 10 bases between crossovers, which is slightly shy of one complete 10.5 base turn. This causes the two domains to twist about 10° relative to each other. In contrast, the DAE in FIG. 8c has 21 bases between crossovers, and is relaxed with the two domains perfectly aligned. FIG. 8d shows a TX with odd numbers of half turns between domains.¹² In this case, both the upper and lower domains are seen to rotate in the same direction relative to the middle domain—about 3°, with the upper domain turning a bit more than the lower one. FIG. 8e, shows a TX with an even number of half turns between junctions.²⁷ In this case, all the helix axes are parallel, but the upper and lower domains are only 163° separated about the middle domain. In FIG. 8f, a DX with Parallel helices, and an Even number of half turns between domains (DPE) is shown. For this case, the helical domains are parallel.

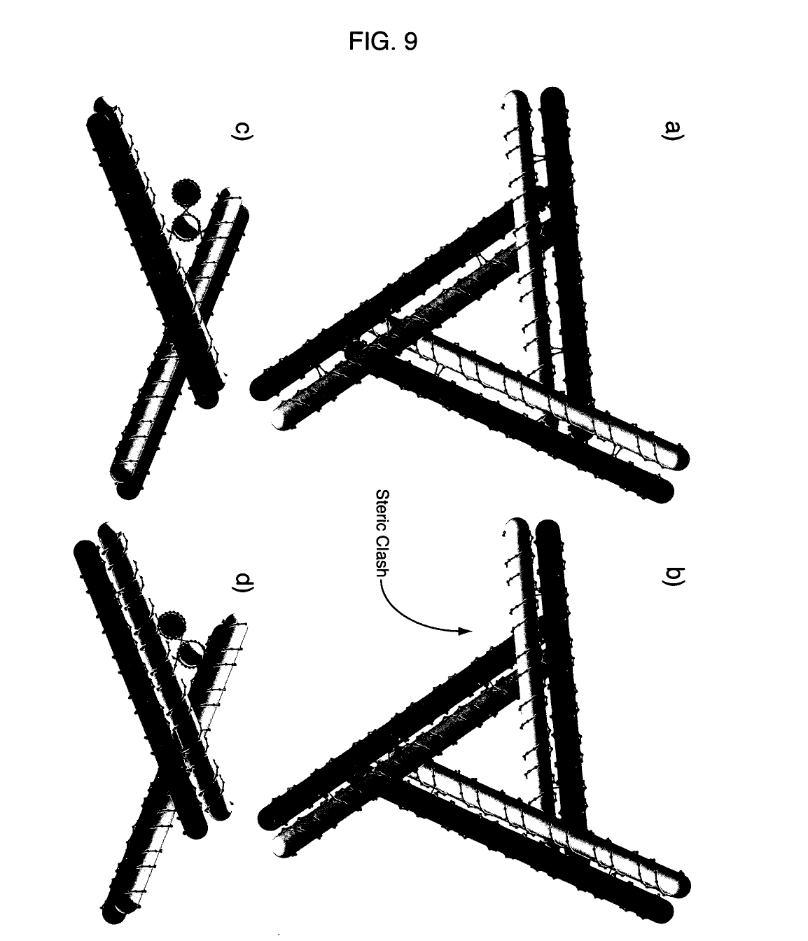

Sometimes, an SDN structure may have entirely undistorted double-helices, and all its crossovers relaxed and yet it may still be geometrically forbidden because of steric clashes between parts of the molecule that appear far apart from the point of view of primary or secondary structure. Consider the tensegrity triangles shown in FIG. 9. The single domain triangles, shown with yellow base stacks, have been reinforced by adding one double helix along each edge—in each case making a DAE. It would seem from Panels a and b that the two structures are more or less equally promising, even though the DX crossovers differ in location between the two structures by one base. The structures are too large for conventional physical models to distinguish between them clearly. Precise modeling with the computer program of this invention, however, reveals that while the structure in a and c is promising, the structure in b and d has a steric clash. When viewed along a duplex axis in d, the model shows an overlap between the outer, gray domain and the inner domain on the next edge of the triangle.

Models are fairly straightforward to build using the computer program of this invention, with the most complicated ones rarely taking more than a few hours for the experienced user. This time can be reduced as libraries of SDN structures are assembled, to be used as future building blocks. As shown in the case of tensegrity triangles, geometric arguments are sufficient to explain qualitatively which structures form multimers more easily than others. In particular, we have shown that tensegrity triangles tend to form well when the geometrical strain is less than 4%, and tend to form multimers when the geometrical strain is higher.

The foregoing description details certain embodiments of the invention. It will be appreciated, however, that no matter how detailed the foregoing appears in text, the invention can be practiced in many ways. The scope of the invention should therefore be construed in accordance with the appended claims and any equivalents thereof.

### REFERENCES

1 N. C. Seeman, SciAm. Persistence length, Hagerman, 1985
2 N. R. Kallenbach, R.-I. Ma, A. J. Wand, G. H. Veeneman, J. H. van Boom, and N.
C. Seeman, Fourth rank immobile nucleic acid junctions, J. Biomol. Struct. Dynam. 1983, 1, 159-168.
3 R.-I. Ma, N. R. Kallenbach, R. D. Sheardy, M. L. Petrillo, and N. C. Seeman, Three-arm nucleic acid junctions are flexible, Nucleic Acids Res, 1986, 14, 9745-9753.
4 I. V. Ouporov, and N. B. Leontis, Refinement of the solution structure of a branched DNA three-way junction, Biophys. J. 1995, 68, 266-274.
5 M. L. Petrillo, C. J. Newton, R. P. Cunningham, R.-I. Ma, N. R. Kallenbach, and N. C. Seeman, The ligation and flexibility of four-arm DNA junctions, Biopolymers, 1988,27, 1337-1352.
6 J. Qi, X. Li, X. Yang, and N. C. Seeman, Ligation of triangles built from bulged 3-arm DNA branched junctions, J. Am. Chem. Soc., 1996, 118, 6121-6130.
7 T.-J. Fu, and N. C. Seeman, DNA double-crossover molecules, Biochemistry, 1993, 32, 3211-3220.
8 C. Mao, W. Sun, and N. C. Seeman, Designed two-dimensional DNA Holliday junction arrays visualized by atomic force microscopy, J. Am. Chem. Soc., 1999, 121,5437-5443.
9 P. Sa-Ardyen, A. V. Vologodskii, and N. C. Seeman, The flexibility of DNA double crossover molecules, Biophys. J., 2003,84,, 3829-3837.
10 N. C. Seeman, Interactive design and manipulation of macro-molecular architecture utilizing nucleic acid junctions, J. Mol. Graphics, 1985, 3, 34-39.
11 N. C. Seeman, Physical models for exploring DNA topology, J. of Biomol. Struct. and Dyns., 1988,5, 997-1004.
12 T. H. LaBean, H. Yan, J. Kopatsch, F. Liu, E. Winfree, J. H. Reif, and N. C. Seeman, The construction, analysis, ligation and self-assembly of DNA triple crossover complexes, J. Am. Chem. Soc., 2000, 122, 1848-1860.
13 Z. Shen, H. Yan, T. Wang, and N. C. Seeman, Paranemic crossover DNA: a generalized Holliday structure with applications in nanotechnology, J. Am. Chem. Soc., 2004, 126, 1666-1674.
14 F. Mathieu, S. Liao, C. Mao, J. Kopatsch, T. Wang, and N. C. Seeman. Six-helix bundles designed from DNA, Nano Lett., 2005, 5, 661-665.
15 H. Yan, S. H. Park, G. Finkelstein, J. H. Reif, and T. H. LaBean, DNA-templated self-assembly of protein arrays and highly conductive nanowires, Science, 2003, 301, 1882-1884.
16 C. Mao, W. Sun, Z. Shen, and N. C. Seeman, A DNA nanomechanical device based on the B-Z transition, Nature, 1999, 397, 144-146.
17 H. Yan, X. Zhang, Z. Shen, and N. C. Seeman, A robust DNA mechanical device controlled by hybridization topology, Nature, 2002,415, 62-65.
18 W. B. Sherman, and N. C. Seeman, A precisely controlled DNA biped walking device, Nano Lett., 2004, 4, 1203-1207.
19 S. Liao, and N. C. Seeman, Translation of DNA signals into polymer assembly instructions, Science, 2004, 306, 2072-2074.
20 D. Liu, M. Wang, Z. Deng, R. Walulu, and C. Mao, Tensegrity: construction of rigid DNA triangles with flexible four-arm DNA junctions, J. Am. Chem. Soc., 2004, 126, 2324-2325.
21 J. Chen and N. C. Seeman, Synthesis from DNA of a molecule with the connectivity of a cube, Nature, 1991, 350, 631-633.
22 Sontag, E. D., Mathematical Control Theory: Deterministic Finite Dimension Systems, Second Edition, 1998 Springer-Verlag. LIST RELEVANT PAGES.
23 J. Wang, Helical repeat of DNA in solution, Proc. Nat. Acad. Sci. U. S. A., 1979, 76, 200-203.
24 D. Rhodes, A. Klug, Helical periodicity of DNA determined by enzyme digestion, Nature, 1980, 286, 573-578.
25 M. H. Caruthers, Gene synthesis machines—DNA chemistry and its uses, Science, 1985, 230,281-285.
26 A. Carbone, C. Mao, P. E. Constantinou, B. Ding, J. Kopatsch, W. B. Sherman, N. C. Seeman, 3D fractal DNA assembly from coding, geometry and protection, Natural Computing, 2004, 3, 235-252.
27 T. H. LaBean, E. Winfree, and J. H. Reif, Experimental progress in computation by self-assembly of DNA tilings, DIMACS Series in Discrete Mathematics and Theoretical Computer Science, edited by E. Winfree and D. K. Gifford, American Mathematical Society, Providence, R.I. 123-140, 2000, Vol. 54.
28 P. K. Maiti, T. A. Pascal, N. Vaidehi, W. A. Goddard, The stability of Seeman JX DNA topoisomers of paranemic crossover (PX) molecules as a function of crossover number. Nucleic Acids Res., 2004, 32, 6047-6056.
29 Metrowerks Corp., 7700 West Parmer Lane, Austin, Tex. 78729 USA, http://www.metrowerks.com.

1. A method of computer modeling a nucleic acid structure model comprising:
a) using a computer to construct a nucleic acid structure model comprising segments defining segment lengths and segment angles;
b) adjusting the segment angle to minimize the error between a segment angle and a target segment angle, or adjusting the segment length to minimize the error between a segment length and a target segment length, or both.

2. The method of claim 1, wherein step b) comprises the steps of:
i. calculating a segment length error or a segment angle error;
ii. calculating the magnitude of response using the segment length error or segment angle error;
iii. calculating a relaxation vector based on magnitude of response;
iv. reiterating steps i) to iii) with a different segment length or segment angle;
V. applying relaxation vectors calculated in the reiteration steps of iv) to vertices to adjust a segment length or segment angle.

3. The method of claim 1, wherein the segments represent at least two bases, a backbone linkage, rise of a helix, and optionally a nucleoside or tether.

4. The method of claim 1, wherein the nucleoside is represented as a vertex, and the segments represent at least two bases, a backbone linkage, rise of a helix, and optionally, a tether.

5. The method of claim 2, further comprising the step of: comparing the overall error of the segment angles to the overall segment angle error tolerance or comparing the overall error of the segment lengths to the overall segment length error tolerance.

6. The method of claim 2, further comprising the step of determining if the sum of all relaxation vectors of a vertex is less than a specified equilibrium tolerance.

7. The method of claim 3, wherein the nucleic acid structure is outputted to an output device during the computer modeling process.

8. The method of claim 3, wherein the segment length error or segment angle error is outputted to an output device during the computer modeling process.

9. The method of claim 3, wherein step a) comprises the step of inputting one or more of a nucleic acid sequence, orientation or location of a nucleic acid structure and structure parameters of a nucleic acid structure.

10. The method of claim 3 further comprising the step of eliminating collisions in the model.

11. The method of claim 3, additionally comprising the step of producing a nucleic acid sequence based on the connectivity and association of the strands.

12. A computer readable medium having instructions stored thereon which configure a general purpose computer to perform the method of claim 1.

13. A molecular modeling apparatus comprising:
An input device for accepting user commands to construct a nucleic acid structure;
Means for outputting a multi-dimensional representation of said nucleic acid structure;
Means for minimizing the segment length errors and segment angle errors of the structure.

14. The molecular modeling apparatus of claim 13, wherein the segments represent at least two bases, a backbone linkage, rise of a helix, and optionally a nucleoside or tether.

15. The molecular modeling apparatus of claim 13, wherein the nucleoside is represented as a vertex, and the segments represent at least two bases, a backbone linkage, rise of a helix, and optionally, a tether.

16. The molecular modeling apparatus of claim 14, additionally comprising means for outputting one or more of the overall segment length error, overall segment angle error, a segment length error and a segment angle error.

17. The molecular modeling apparatus of claim 14, additionally comprising means for modifying the nucleic acid structure.

18. The molecular modeling apparatus of claim 14, additionally comprising means for automated script construction of nucleic acid structures.

19. The molecular modeling apparatus of claim 14, additionally comprising means for producing a nucleic acid sequence based on the connectivity and association of the strands.

20. The molecular modeling apparatus of claim 14, additionally comprising means for eliminating collisions in the model.
